(19) United States
(12) Patent Application Publication
(10) Pub. No.: US 2022/0410905 A1
(43) Pub. Date: Dec. 29, 2022

(54) Method and System for Recognizing an Object Which Is Turning Off

(71) Applicant: Bayerische Motoren Werke Aktiengesellschaft, Muenchen (DE)

(72) Inventor: Daniel OBERMAIER, Wolnzach (DE)

(21) Appl. No.: 17/779,969

(22) PCT Filed: Nov. 3, 2020
(86) PCT No.: PCT/EP2020/080780

§ 371 Date: May 25, 2022

(30) Foreign Application Priority Data
Nov. 26, 2019 (DE) 10 2019 132 006.2

(51) Int. Cl. B60W 40/04; B60W 30/14

(52) U.S. Cl. CPC B60W 40/04; B60W 30/14; B60W 2554/4045

(57) ABSTRACT

A method for recognizing an object which is turning off includes detecting a vehicle in front by way of a surroundings sensor system of an ego vehicle; determining a probability of the vehicle in front turning off; and marking the vehicle in front as an object which is turning off when the probability of turning off is equal to or greater than a predetermined threshold value.

### BACKGROUND AND SUMMARY OF THE INVENTION

The present disclosure relates to a method for recognizing an object which is turning off, a storage medium for executing the method, a system for recognizing an object which is turning off, and a vehicle having such a system. The present disclosure relates in particular to reliable recognition of vehicles which are turning off, for example, for an adaptive cruise control of the vehicle.

Driver assistance systems for automated driving are increasingly gaining importance. Automated driving can be carried out with various degrees of automation. Exemplary degrees of automation are assisted, partially automated, highly automated, or fully automated driving. These degrees of automation were defined by the Bundesanstalt fur StraBenwesen [German Federal Highway Research Institute] (BASt) (see BASt publication “Forschung kompakt [compact research]”, edition November 2012). For example, the vehicles at level 4 are underway fully autonomously in urban operation.

The driver assistance system for automated driving uses sensors which perceive the surroundings on a visual basis, both in the range visible to humans and also in the invisible range. The sensors can be, for example, a camera, a radar, and/or a LiDAR. In addition to high-accuracy maps, these are the primary signal sources for driver assistance systems for automated driving.

An adaptive cruise control (ACC) is presently often used in vehicles. The adaptive cruise control is a cruise control system which takes into consideration the distance to a preceding vehicle as an additional feedback and control variable in the regulation. In the adaptive cruise control, the position and the velocity of the preceding vehicle are determined using a sensor and the velocity and the distance are adaptively regulated using engine and braking interventions. In the case of such a longitudinal regulation, unnecessary braking operations of the vehicle can occur in dependence on a movement pattern of the preceding vehicle, which may be perceived to be unpleasant by the occupants.

It is an object of the present disclosure to specify a method for recognizing an object which is turning off, a storage medium for executing the method, a system for recognizing an object which is turning off, and a vehicle having such a system which enable improved recognition of turning off. In particular, it is an object of the present invention to improve an adaptive cruise control.

This object is achieved by the claimed invention.

According to one independent aspect of the present disclosure, a method for recognizing an object which is turning off is specified. The method comprises detecting a preceding vehicle by way of a surroundings sensor system of an ego vehicle; determining a probability of turning off for the preceding vehicle; and marking the preceding vehicle as an object which is turning off if the probability of turning off is equal to or greater than a predetermined threshold value.

The predetermined threshold value can be, for example, 50% or more, 60% or more, 70% or more, 80% or more, or 90% or more.

It is recognized according to an embodiment of the invention whether the preceding vehicle is a vehicle turning off or not. This is implemented by way of a vehicle turning off probability. In the determination of the vehicle turning off probability or the recognition of the object which is turning off, a plurality of criteria can be used which are designed in such a way as to be able to increase or optimize the probability that the preceding vehicle is actually a vehicle turning off.

In particular, a vehicle turning off probability is determined for a vehicle driving in front of the ego vehicle and the preceding vehicle is marked as an object which is turning off if the vehicle turning off probability is equal to or greater than a predetermined threshold value. The turning off of the marked vehicle can be taken into consideration, for example, in the control or regulation of the velocity of the vehicle. For example, weights of the regulator can be adapted on the basis of the vehicle turning off probability. The regulator can thus already have a positive momentum be applied again in the case of a recognized vehicle turning off. Excessively strong and long braking for a vehicle turning off is thus prevented by the vehicle turning off recognition and the ego vehicle accelerates earlier.

The determination of the vehicle turning off probability for the preceding vehicle is preferably carried out based on at least one first criterion. The at least one first criterion can be selected from the group which comprises a vehicle pulling off, a turn signal, a lateral velocity, a relative velocity, an object velocity, and a heading, or consists thereof.

The method preferably furthermore comprises scaling the vehicle turning off probability using at least one second criterion. The at least one second criterion can be selected from the group which comprises a vehicle turning off distance, a vehicle turning off curvature, a vehicle turning off longitudinal velocity, a vehicle turning off lateral velocity, a distance to the roundabout, a distance to the T-intersection, a vehicle turning off lateral distance, and a vehicle turning off lateral acceleration, or consists thereof.

The method preferably furthermore comprises applying an influence value to at least one criterion of the at least one first criterion and the at least one second criterion. The influence value can be between 0 and 1, wherein 0 defines no influence and 1 defines a maximum influence.

The method preferably furthermore comprises debouncing at least one criterion of the at least one first criterion and the at least one second criterion. The debouncing is carried out using a debouncing time, which can be suitably selected and can be in the range of several seconds depending on the criterion.

The preceding vehicle is preferably only marked as an object which is turning off when an approval of the vehicle turning off recognition based on a road course takes place. If the approval does not take place, the preceding vehicle is not marked as an object which is turning off and is thus also not taken into consideration, for example, in the cruise control of the vehicle.

According to a further independent aspect, a software (SW) program is specified. The SW program can be configured to be executed on one or more processors, to thus execute the method described in this document for recognizing an object which is turning off.

According to a further independent aspect, a storage medium is specified. The storage medium can comprise a SW program, which is configured to be executed on one or more processors, to thus execute the method described in this document for recognizing an object which is turning off.

According to a further independent aspect of the present disclosure, a system for recognizing an object which is turning off is specified. The system comprises a detection module, which is configured to detect a preceding vehicle by way of a surroundings sensor system of an ego vehicle; and at least one processor unit, which is configured to determine a vehicle turning off probability for the preceding vehicle and to mark the preceding vehicle as an object which is turning off if the vehicle turning off probability is equal to or greater than a predetermined threshold value.

The system can implement the aspects of the method described in this document for recognizing an object which is turning off. Similarly, the method can implement the aspects of the system described in this document for recognizing an object which is turning off.

The system preferably comprises a control module, which is configured to set a velocity of the vehicle based on the vehicle turning off probability of the preceding vehicle.

The control module can preferably be configured to set the velocity of the vehicle based on the vehicle turning off probability only when the preceding vehicle is marked as a vehicle turning off If the preceding vehicle is not marked as a vehicle turning off, a regulation of the velocity can be carried out without the assumption of turning off, so that reliability of the system can be improved.

The detection module and/or the at least one processor unit and/or the control module can be implemented in a common software and/or hardware module. Alternatively thereto, the detection module and/or the at least one processor unit and/or the control module can each be implemented in separate software and/or hardware modules.

The system is preferably configured for automated driving. In particular, the driver assistance system can be an adaptive cruise control (ACC).

The adaptive cruise control is configured to maintain a safety distance to the preceding vehicle. The adaptive cruise control can comprise a target velocity mode and a time interval mode in some embodiments. In the target velocity mode, a velocity predefined or desired by the driver is to be maintained. In the time interval mode, a time lead to a preceding vehicle is to be maintained.

The term “automated driving” can be understood in the scope of the document as driving having automated longitudinal or lateral control or autonomous driving having automated longitudinal and lateral control. Automated driving can involve, for example, driving over a longer time on the freeway or driving for a limited time in the context of parking or maneuvering. The term “automated driving” comprises automated driving with an arbitrary degree of automation. Exemplary degrees of automation are assisted, partially automated, highly automated, or fully automated driving. These degrees of automation were defined by the Bundesanstalt fur StraBenwesen [German Federal Highway Research Institute] (BASt) (see BASt publication “Forschung kompakt [compact research]”, edition November 2012).

In assisted driving, the driver continuously executes the longitudinal or lateral control, while the system takes over the respective other function in certain limits. In partially automated driving (TAF), the system takes over the longitudinal and lateral control for a certain period of time and/or in specific situations, wherein the driver has to continuously monitor the system as in assisted driving. In highly automated driving (HAF), the system takes over the longitudinal and lateral control for a certain period of time without the driver having to continuously monitor the system; however, the driver has to be capable of taking over the vehicle control in a certain time. In fully automated driving (VAF), the system can automatically manage the driving in all situations for a specific application; a driver is no longer necessary for this application.

The above-mentioned four degrees of automation correspond to the SAE levels 1 to 4 of the norm SAE J3016 (SAE—Society of Automotive Engineering). For example, highly automated driving (HAF) corresponds to level 3 of the norm SAE J3016. Furthermore, the SAE level 5 is also provided as the highest degree of automation in SAE J3016, which is not included in the definition of the BASt. The SAE level 5 corresponds to driverless driving, in which the system can automatically manage all situations like a human driver during the entire journey; a driver is generally no longer required.

According to a further independent aspect of the present disclosure, a vehicle, in particular a motor vehicle, is specified. The vehicle comprises the system for recognizing an object which is turning off according to the embodiments of the present disclosure.

The term vehicle comprises passenger vehicles, trucks, buses, motorhomes, motorcycles, etc., which are used for conveying persons, goods, etc. In particular, the term comprises motor vehicles for conveying persons.

Exemplary embodiments of the disclosure are illustrated in the figures and are described in more detail hereinafter.

### BRIEF DESCRIPTION OF THE DRAWINGS

FIG. 1A shows a flow chart of a method for recognizing an object which is turning off according to embodiments of the present disclosure.

FIG. 1B schematically shows a system for recognizing an object which is turning off according to embodiments of the present disclosure.

FIGS. 2 to 4 show criteria for recognizing a vehicle turning off according to embodiments of the present disclosure.

FIG. 5 shows a driving path according to embodiments of the present disclosure.

FIGS. 6 to 14 show further criteria for recognizing a vehicle turning off according to embodiments of the present disclosure.

### DETAILED DESCRIPTION OF THE DRAWINGS

In the following, identical reference signs are used for identical and identically acting elements, if not indicated otherwise.

According to the embodiments of the present disclosure, it is recognized whether or not the preceding vehicle is a vehicle turning off. This is implemented by way of a vehicle turning off probability. In the determination of the vehicle turning off probability or the recognition of the object which is turning off, a plurality of criteria can be used which are designed so as to be able to increase or optimize the probability that the preceding vehicle is actually a vehicle turning off.

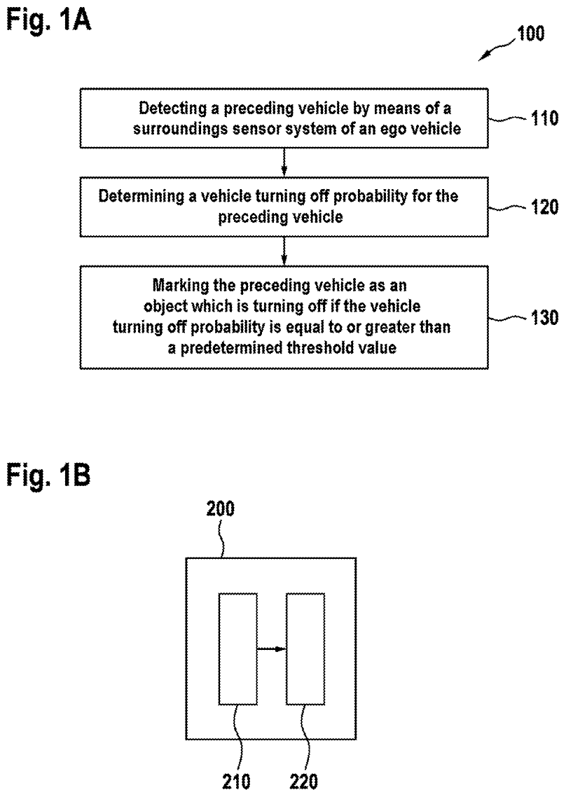

FIG. 1A shows a flow chart of a method 100 for recognizing an object which is turning off according to embodiments of the present disclosure. The method 300 can be implemented by corresponding software, which is executable by one or more processors (for example a CPU).

The method 100 comprises, in block 110, detecting a preceding vehicle by way of a surroundings sensor system of an ego vehicle; in block 120, determining a vehicle turning off probability for the preceding vehicle; and, in block 130, marking the preceding vehicle as an object which is turning off if the vehicle turning off probability is equal to or greater than a predetermined threshold value.

The system 200 corresponding to the method is shown in FIG. 1B and comprises a detection module 210, which is configured to detect a preceding vehicle by way of a surroundings sensor system of an ego vehicle; and at least one processor unit 220, which is configured to determine a vehicle turning off probability for the preceding vehicle and to mark the preceding vehicle as an object which is turning off if the vehicle turning off probability is equal to or greater than a predetermined threshold value.

The driver assistance system 100 can be configured, for example, for an adaptive cruise control (ACC). The adaptive cruise control is a cruise control system which takes into consideration the distance to a preceding vehicle as an additional feedback and regulating variable in the regulation. In the adaptive cruise control, the position and the velocity of the preceding vehicle are ascertained using a sensor and the velocity and the distance are adaptively regulated using engine and braking interventions (longitudinal regulation).

To plan and carry out such automated driving, items of surroundings information of the surroundings sensor system, which observes the vehicle surroundings, are accepted by the driver assistance system 200. In particular, the vehicle can comprise at least one surroundings sensor, which is configured to record surroundings data which specify the vehicle surroundings. The at least one surroundings sensor can comprise, for example, a LiDAR system, one or more radar systems, and/or one or more cameras.

In the following, exemplary criteria for the vehicle turning off recognition are explained. The following criteria, aspects, and partial aspects can be combined and used in a suitable manner. For example, different criteria can be at least partially applied for vehicles pulling off (low lateral velocity and lateral acceleration) and vehicles turning off (high lateral velocity and increasing lateral acceleration).

An exemplary function for the vehicle turning off recognition according to the invention can be defined as follows:

Vehicle turning off probability*vehicle turning off scaling AND road approval

The product of the vehicle turning off probability and the vehicle turning off scaling can be at most 1 and can have a hysteresis.

### Vehicle Turning Off Probability (Vehicle Turning Off Sum)

The vehicle turning off probability can be specified by a vehicle turning off sum. The vehicle turning off sum can comprise two or more addends, which influence or specify the vehicle turning off probability.

The addends can each form a contribution to the sum, which is defined as the product of a value and influence. In particular, an influence or a weighting can be defined and included for each of the addends. The influence or the weighting can be specified as a scalar. For example, the influence or the weighting of the turn signal can be 0.3. The value of the “turn signal” can either be 0 (no turn signal set) or 1 (no turn signal set), wherein the weighted value in the total is then 0.3 (1·0.3).

In an exemplary embodiment, the vehicle turning off sum can be defined as follows:

Vehicle pulling off+turn signal+lateral velocity+relative velocity+object-X velocity+heading (+exit)

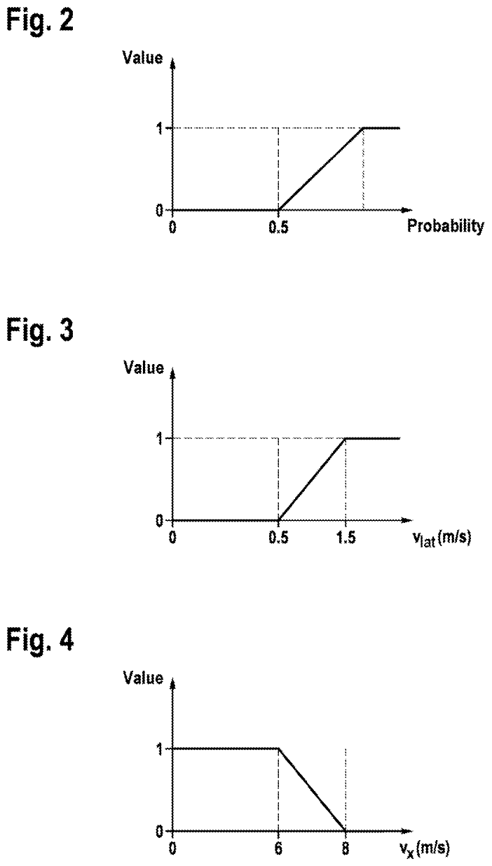

A contribution of the vehicle pulling off can be provided with a scaling and optionally an influence. FIG. 2 is a graph (0-1 function), which shows a value of the vehicle pulling off as a function of the vehicle pulling off probability. In this example, the vehicle turning off supplies an increasing contribution to the vehicle turning off sum (scaling) from a probability of 50%. The value is at most 1 and can be provided with an influence. If the influence is, for example, 0.4, the contribution of the vehicle turning off to the vehicle turning off sum is at most 1·0.4=0.4.

If the value of the vehicle pulling off probability decreases below a certain value, for example 0.9, debouncing can take place, i.e., a registration of the change only takes place after a debouncing time.

A contribution of the turn signal is a yes/no decision and can be provided with an influence of, for example, 0.3. Optionally, debouncing can take place with a debouncing time of, for example, 2 seconds.

A contribution of the lateral velocity can be provided with a scaling and optionally an influence. FIG. 3 is a graph (0-1 function), which shows a value as a function of the lateral velocity. In this example, the lateral velocity supplies an increasing contribution to the vehicle turning off sum (scaling) from a lateral velocity of 0.5 m/s. For example, the value can increase to 1.5 m/s and can then be constant. The value is at most 1 and can be provided with an influence. If the influence is, for example, 0.3, the contribution of the lateral velocity to the vehicle turning off sum is then at most 1·0.3=0.3.

The relative velocity is a relative velocity between the (ego) vehicle and the preceding vehicle. The contribution of the relative velocity can be provided with a suitable influence. The relative velocity can be, for example, a filtered relative velocity having time constants for running up and running down.

A contribution of the object-X velocity (longitudinal velocity vx of the preceding vehicle) can be provided with a scaling and optionally an influence. FIG. 4 is a graph (1-0 function) which shows a value of the contribution as a function of the longitudinal velocity vₓ. In this example, the object-X velocity supplies a maximum contribution to the vehicle turning off sum at low velocities and decreases at higher velocities (scaling). The value is at most 1 and can be provided with an influence. If the influence is, for example, 0.4, the contribution of the object-X velocity to the vehicle turning off sum is then at most 1·0.4=0.4.

The heading or the heading angle is calculated for the driving path. The driving path moves approximately in the range of a circular path and is defined by the curvature value. This is shown in FIG. 5 by the following equations:

$$φ = β - μ \\ tan ( 90 ° - α ) = tan β = \frac{x}{R - y} \\ φ = arctan ( \frac{x}{R - y} ) - μ$$

μ is the heading, φ is the heading of the driving path, y is the object lateral distance, and R is the radius (=1/curvature).

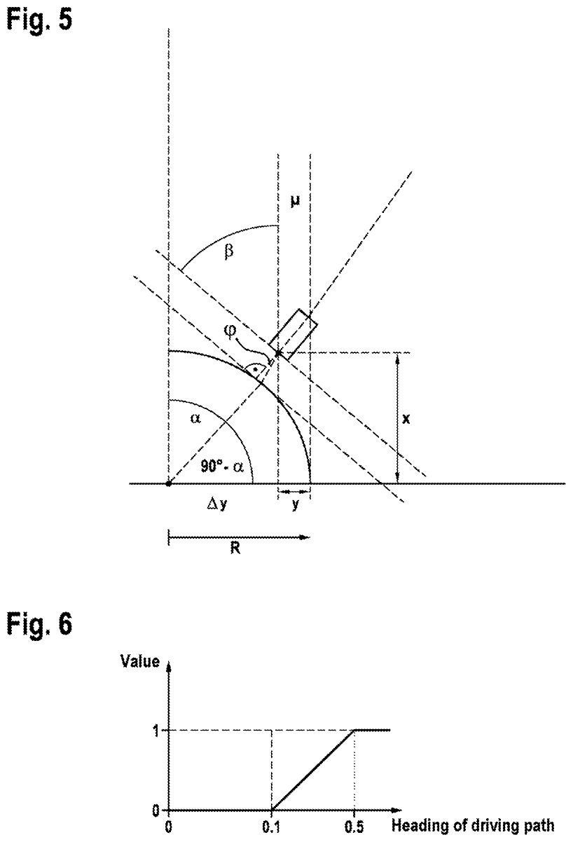

At greater heading angles, the contribution to the vehicle turning off sum increases, as shown in FIG. 6. The value is at most 1 and can be provided with an influence. If the influence is, for example, 0.4, the contribution of the heading to the vehicle turning off sum is then at most 1·0.4=0.4.

### Vehicle Turning Off Scaling

In addition to the vehicle turning off probability, a vehicle turning off scaling can be used for an approval of the vehicle turning off recognition, which is multiplied by the vehicle turning off probability. The product of vehicle turning off probability and vehicle turning off scaling can be at most 1. In particular, the vehicle turning off probability and vehicle turning off scaling can be defined in such a way that their product can be at most 1, which corresponds to an approval of the vehicle turning off recognition. In particular, it is more probable that the preceding vehicle is a vehicle turning off the higher the product of vehicle turning off probability and vehicle turning off scaling is.

The vehicle turning off scaling in particular maps an influence of a lateral position and lateral velocity in relation to the driving path on the vehicle turning off recognition. The lateral velocity can be incorporated in the vehicle turning off recognition in such a way that the vehicle turning off recognition is only active at greater lateral velocities of the potential vehicle turning off. Errors in the vehicle turning off recognition can be reduced in this way.

The vehicle turning off scaling can comprise two or more factors which influence or specify the vehicle turning off recognition. In one exemplary embodiment, the two or more factors can be selected from the group which comprises a vehicle turning off distance, a vehicle turning off curvature, a vehicle turning off longitudinal velocity, a vehicle turning off lateral velocity, a distance to the roundabout, a distance to the T-intersection, a vehicle turning off lateral distance, and a vehicle turning off lateral acceleration, or which consists thereof.

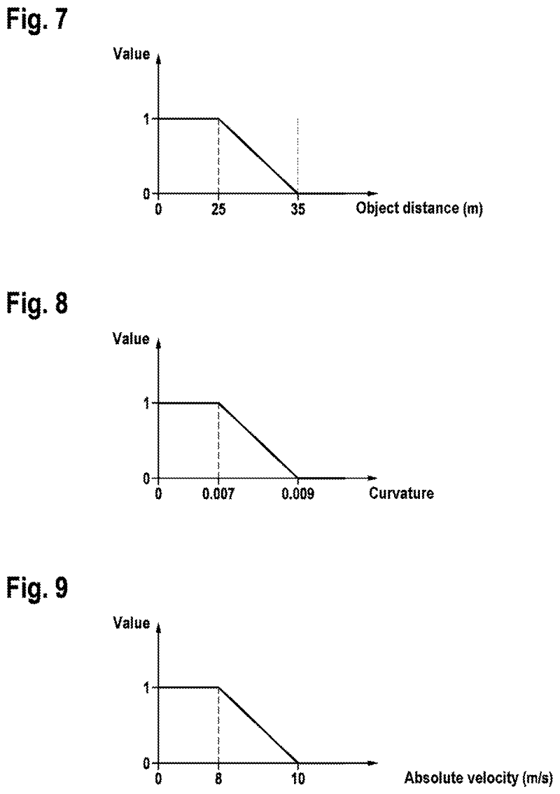

The vehicle turning off distance is used to perform limiting of the vehicle turning off recognition to a maximum range on the basis of a simplified driving path calculation (1-0 function). In particular, greater object distances can be removed, as shown in FIG. 7.

The vehicle turning off curvature prevents incorrect triggering of the vehicle turning off recognition by restricting the curvature values of the driving path. This is shown by way of example in FIG. 8. Optionally, at certain curvature values, for example, >0.009, debouncing can be used. The vehicle turning off curvature is advantageous in particular for certain scenarios having curvatures in which no vehicles turning off are to be recognized, for example, in the case of a road having a frequent change of curvature, following the preceding vehicle in curves, and merging in of the ego vehicle behind the preceding vehicle.

The vehicle turning off longitudinal velocity ensures that the vehicle turning off recognition is only active at low longitudinal velocities of the preceding vehicle. This can be implemented using a 1-0 function, as shown by way of example in FIG. 9.

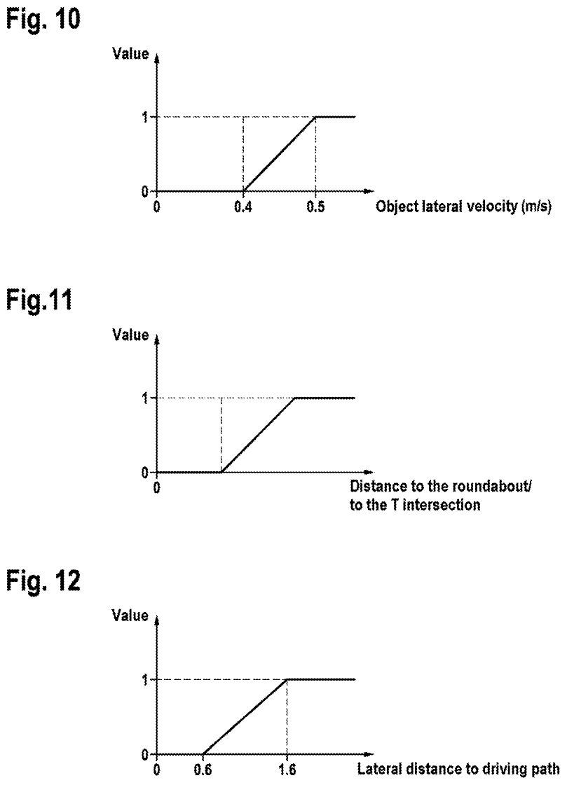

The vehicle turning off lateral velocity is used so that the vehicle turning off recognition is only active at high lateral velocities of the preceding vehicle. A reduction of errors in the vehicle turning off recognition can be achieved in this way. The vehicle turning off lateral velocity can be implemented using a 0-1 function, as shown by way of example in FIG. 10.

The vehicle turning off lateral velocity is advantageous in particular for certain scenarios, in which no vehicles turning off are to be recognized, for example, in the case of offset driving (i.e., the ego vehicle and the preceding vehicle are located on different lanes) and/or in the case of slow pulling off of the preceding vehicle.

The distance to the roundabout avoids errors before and in the roundabout. Similarly, the distance to the T-intersection avoids errors with respect to the T-intersection. Both can be implemented by a 0-1 function, as shown in the example of FIG. 11.

The vehicle turning off lateral distance to the driving path can be represented as a 0-1 function, as shown in FIG. 12. The vehicle turning of lateral distance can be defined as follows with reference to FIG. 5:

Lateral distance=A−R,

wherein A=√(R−y)²+x²

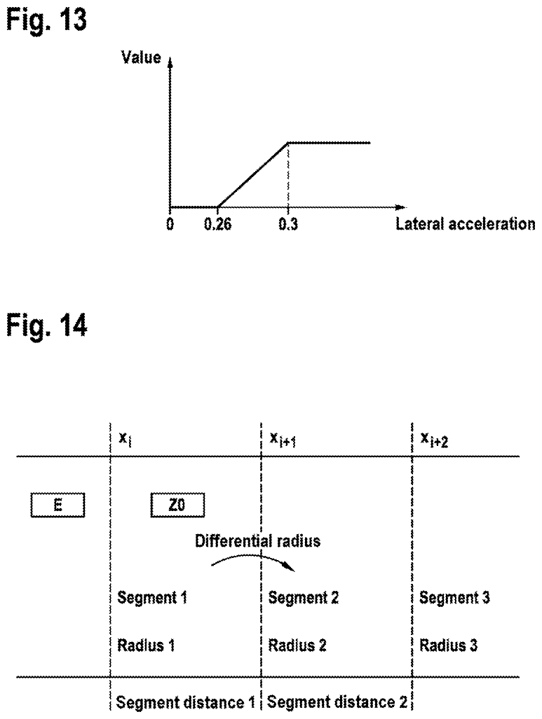

The vehicle turning off lateral acceleration ensures that vehicles turning off are only actively approved from a specific lateral acceleration. The vehicle turning off lateral acceleration can be represented as a 0-1 function, as shown in FIG. 13.

### Road Spproval

The road approval can be implemented by the observation of a road course. Incorrect triggering of the vehicle turning off recognition is to be prevented by the observation of the road course in front of the ego vehicle.

For this purpose, the road course can be divided into multiple segments, in which different radii (curvatures) apply. Depending on the situation, various road radii can be permitted to approve the vehicle turning off recognition.

With reference to FIG. 14, three segments xᵢ, xᵢ₊₁, xᵢ₊₂, the ego vehicle E, and the preceding vehicle ZO are shown.

If the radius 1 is less than a predefined value and if the potential vehicle turning off is located in segment 1, no vehicle turning off recognition takes place. In a case in which the radius 2 is less than the predefined value and if the potential vehicle turning off is close to xᵢ₊₁ or the segment distance 1 is small and the differential radius is greater than the predefined value, no vehicle turning off recognition takes place. In the case in which the potential vehicle turning off is located in segment 2 and the radius 2 is less than a predefined value, no vehicle turning off recognition takes place. In a case in which the radius 3 is less than the predefined value and if a sum of the segment distance 1 and the segment distance 2 is less than the predefined value, no vehicle turning off recognition also takes place. In the case in which the potential vehicle turning off is located in segment 3 and the radius 3 is less than a predefined value, no vehicle turning off recognition takes place.

### Further Possible Conditions for the Vehicle Turning Off Recognition

One or more of the following aspects can optionally be used in the vehicle turning off recognition
Initial recording delay (vehicle merging in): The vehicle turning off is to be a target object for at least a certain time, for example 3 seconds, before the recognition.
Curvature debouncing: A certain time, for example 4 seconds, from a determined curvature value. In this way, incorrect triggering when cornering can be avoided upon the driving path passing over objects.
Excluding certain object types: for example, truck, bus, bicycle, pedestrian, motorcycle. Other object types can not be excluded here.
Hysteresis: The value remains at 1 until it has fallen below a certain value, for example 0.7.

It is recognized according to an embodiment of the invention whether or not the preceding vehicle is a vehicle turning off. This is implemented by way of a vehicle turning off probability. In the determination of the vehicle turning off probability or the recognition of the object which is turning off, a plurality of criteria can be used which are designed so as to be able to increase or optimize the probability that the preceding vehicle is actually a vehicle turning off.

Although the invention was illustrated and explained in more detail by preferred exemplary embodiments, the invention is not thus restricted by the disclosed examples and other variations can be derived therefrom by a person skilled in the art without leaving the scope of protection of the invention. It is therefore clear that a large number of possible variations exists. It is also clear that embodiments mentioned by way of example actually only represent examples, which are not to be interpreted in any way as limiting, for example, the scope of protection, the possible applications, or the configuration of the invention. Rather, the preceding description and the description of the figures make it possible for a person skilled in the art to specifically implement the exemplary embodiments, wherein a person skilled in the art, knowing the disclosed concept of the invention, can perform various modifications, for example with respect to the function or the arrangement of individual elements mentioned in an exemplary embodiment, without leaving the scope of protection defined by the claims and their legal equivalents, such as more extensive explanations in the description.

1.-10. (canceled)

11. A method for recognizing an object which is turning off, the method comprising:
detecting a preceding vehicle by way of a surroundings sensor system of an ego vehicle;
determining a vehicle turning off probability for the preceding vehicle; and
marking the preceding vehicle as the object which is turning off if the vehicle turning off probability is equal to or greater than a predetermined threshold value.

12. The method according to claim 11, wherein the determining of the vehicle turning off probability for the preceding vehicle is carried out based on at least one first criterion which is selected from the group consisting of a vehicle pulling off, a turn signal, a lateral velocity, a relative velocity, an object velocity, and a heading.

13. The method according to claim 12, further comprising:
scaling the vehicle turning off probability using at least one second criterion.

14. The method according to claim 13, wherein the at least one second criterion is selected from the group consisting of a vehicle turning off distance, a vehicle turning off curvature, a vehicle turning off longitudinal velocity, a vehicle turning off lateral velocity, a distance to a roundabout, a distance to a T-intersection, a vehicle turning off lateral distance, and a vehicle turning off lateral acceleration.

15. The method according to claim 13, further comprising:
applying an influence value to at least one of the at least one first criterion or the at least one second criterion.

16. The method according to claim 13, furthermore comprising:
debouncing at least one of the at least one first criterion or the at least one second criterion.

17. The method according to claim 11, wherein the preceding vehicle is marked as an object which is turning off only when an approval of recognition if the vehicle turning off based on a road course takes place.

18. A computer product comprising a non-transitory computer readable medium having stored thereon program code which, when executed on one or more processors, carries out the acts of:
detecting a preceding vehicle by way of a surroundings sensor system of an ego vehicle;
determining a vehicle turning off probability for the preceding vehicle; and
marking the preceding vehicle as an object which is turning off if the vehicle turning off probability is equal to or greater than a predetermined threshold value.

19. A system for recognizing an object which is turning off, the system comprising:
a detection module, which is configured to detect a preceding vehicle by way of a surroundings sensor system of an ego vehicle; and
at least one processor unit, which is configured to:
determine a vehicle turning off probability for the preceding vehicle; and
mark the preceding vehicle as an object which is turning off if the vehicle turning off probability is equal to or greater than a predetermined threshold value.

20. A vehicle comprising the system according to claim 19.

21. The vehicle according to claim 20, wherein the vehicle is a motor vehicle.
